(19) United States
(12) Patent Application Publication
(10) Pub. No.: US 2015/0064532 A1
(43) Pub. Date: Mar. 5, 2015

(54) STABILIZED ELECTROCHEMICAL SEPARATOR STRUCTURES, AND RELATED DEVICES

(71) Applicant: General Electric Company, Schenectady, NY (US)

(72) Inventors: Sundeep Kumar, Bangalore (IN); Dunbar Paul Birnie, III, Princeton, NJ (US)

(73) Assignee: General Electric Company, Schenectady, NY (US)

(21) Appl. No.: 14/012,688

(22) Filed: Aug. 28, 2013

(51) Int. Cl. H01M 2/16

(52) U.S. Cl. CPC H01M 2/1646
USPC 429/102; 252/62.3 E

(57) ABSTRACT

The invention is directed to an electrochemical separator structure. The structure is formed of a material that includes manganese-stabilized beta″-alumina. The manganese is present at a level of about 1% by weight to about 20% by weight. Another embodiment is directed to an energy storage device that includes the electrochemical separator structure.

### BACKGROUND OF THE INVENTION

This application relates generally to electrochemical devices and their various components. In some particular embodiments, the application relates to separator structures for energy storage devices, such as batteries.

Electrolyte structures and compositions are critical components for a number of electrochemical devices, such as fuel cells, various types of batteries, and alkali metal thermal-to-electric converters (AMTEC) devices. Specific examples where electrolytes are used as separator structures include thermal batteries, such as sodium-sulfur and sodium metal chloride batteries. The sodium-metal chloride batteries, with a molten sodium negative electrode (usually referred to as the anode) and a beta-alumina solid electrolyte, are of considerable interest for energy storage applications. In addition to the anode, the batteries include a positive electrode (usually referred to as the cathode) that supplies/receives electrons during the charge/discharge of the battery. The solid electrolyte functions as the membrane or “separator” between the anode and the cathode.

The metal chloride batteries and other types of thermal batteries can be employed in a number of applications, such as uninterruptable power supply (UPS) devices; or as part of a battery backup system for a telecommunications (“telecom”) device, sometimes referred to as a telecommunication battery backup system (TBS). The batteries are often capable of providing power surges (high currents) during the discharge cycle. In an ideal situation, the battery power can be achieved without a significant loss in the working capacity and the cycle life of the battery. The advantageous features of these types of batteries provide opportunities for applications in a number of other end use areas as well.

A typical, general design for metal chloride cells and other types of thermal batteries is depicted in FIG. 2, which will be explained in the detailed description. These batteries usually include a number of compartments and regions for containing, delivering, or receiving the electrochemical components needed for battery reactions, e.g., electrode and electrolyte components.

While various materials can be used to make the separator structure, highly specialized alumina materials are preferred, such as beta″-alumina (beta double prime alumina or “beta prime prime alumina”). For simplicity, the term “beta alumina” will sometimes be used herein to refer to this material, unless otherwise indicated. Beta alumina is known in the art as a unique, isomorphic form of aluminum oxide, characterized by a layered, rhombohedral crystal structure. The material can be used to rapidly transport sodium and other selected ions during electrochemical reactions—a critical parameter for the performance of devices such as the thermal batteries.

The compositions used to form separators based on beta alumina require chemical stabilization. Stabilization has been achieved by the addition of divalent ions that substitute for aluminum. It is thought that this substitution enhances the amount of sodium in each formula unit of the beta alumina structure, thereby increasing the level of ionic conduction necessary for electrolyte function. Examples of stabilizers that have been used for this purpose in the past include lithium oxide (lithia), magnesia, zinc oxide, and yttria. (Sodium ion conductivity for some of the beta alumina separator electrolytes at 300° C. is often in the range of about 0.2 ohm⁻¹cm⁻¹ to about 0.4 ohm⁻¹cm⁻¹).

In recent years, the performance requirements for electrochemical devices such as batteries have been rapidly increasing, because of greater usage in many of the end use applications noted above. In the case of sodium metal halide batteries that rely on beta alumina separators, some of the higher-level requirements relate to power density. The power density can be partially limited by higher ionic resistivity within the separator material.

While current electrolyte separator materials are suitable for some end use applications, there is continuing interest in new materials for the very high-performance applications. The new materials should enable related devices such as batteries to have comparable, or greater, power and/or energy density, as compared to separator materials presently available. In accordance with that objective, the new materials should also be capable of providing separator structures that substantially prevent electronic conductivity, but also exhibit very low resistivity, and hence, relatively high power.

Moreover, the electrolyte separators, e.g., in the form of tubes, usually must possess relatively high strength; and must also be capable of formation into thin-walled structures. The separator structures also must retain mechanical integrity and a specified level of electrochemical performance for an extended period of time—sometimes over many years. Furthermore, the structures should also be formed from materials (e.g., raw materials) that are economical to purchase, and that can be efficiently and reliably stored for use in a commercial setting.

### BRIEF DESCRIPTION

An embodiment of the invention is directed to an electrochemical separator structure. The structure is formed of a material that comprises manganese-stabilized beta″-alumina. The manganese is present at a level of about 1% by weight to about 20% by weight. Another embodiment is directed to an energy storage device, comprising the electrochemical separator structure described in this disclosure.

### BRIEF DESCRIPTION OF THE DRAWINGS

FIG. 1 is an illustration of the crystal structure of a beta″-alumina electrolyte mateiral.

FIG. 2 is a schematic diagram depicting an exemplary electrochemical cell that contains a separator structure.

FIG. 3 is an X-ray powder diffraction pattern for a manganese-stabilized beta″ alumina phase.

FIG. 4 is a graph measuring resistivity as a function of temperature, for a manganese-stabilized beta″-alumina material.

### DETAILED DESCRIPTION

When introducing elements of various embodiments of the present invention, the articles “a,” “an,” “the,” and “said” are intended to mean that there are one or more of the elements, unless otherwise indicated. Moreover, the terms “comprising,” “including,” and “having” are intended to be inclusive, and mean that there may be additional elements other than the listed elements. As used herein, the term “and/or” includes any and all combinations of one or more of the associated listed items. Furthermore, unless otherwise indicated herein, the terms “disposed on”, “deposited on” or “disposed between” refer to both direct contact between layers, objects, and the like, or indirect contact, e.g., having intervening layers therebetween.

Approximating language, as used herein throughout the specification and claims, may be applied to modify any quantitative representation that could permissibly vary without resulting in a change in the basic function to which it may be related. Accordingly, a value modified by a term such as “about” is not limited to the precise value specified. In some instances, the approximating language may correspond to the precision of an instrument for measuring the value.

As alluded to previously, the beta alumina electrolyte structure typically used in batteries, like other types of separators, is placed between an anode and a cathode, keeping the two electrodes apart. In this manner, electrical short circuits are prevented, while enabling the passage of ionic charge carriers. The ionic path effectively closes the electrical circuit during the passage of current within the electrochemical cells of the battery.

In the present invention, the material forming the separator structure comprises beta alumina (specifically, beta″-alumina), and selected amounts of manganese. Manganese must be present at about 1% by weight to about 20% by weight, based on the total weight of the separator structure mateiral. Moreover, in some of the particular embodiments for sodium metal halide batteries, the preferred range is about 5% by weight to about 15% by weight. The manganese may be employed in various forms, e.g., carbonates or oxides. Examples include manganese oxide (e.g., MnO, Mn₃O₄, Mn₂O₃, or combinations thereof); manganese dioxide (MnO₂); and manganese carbonate (MnCO₃).

Additionally, other embodiments that are preferred in some cases require that manganese be used (at these stabilizer levels), to the exclusion of any other stabilizers, like lithium or magnesium. Thus, some of the compositions of this type consist essentially of manganese, alumina, and an ionic conducting material, such as sodium oxide.

Manganese at the levels noted above effectively provides chemical stabilization for the alumina component in the separator. As described previously, the stabilization increases the level of ionic conduction necessary for electrolyte function—especially at the high temperatures required for electrochemical device operation, e.g., greater than about 300° C. The beta alumina structure is thought to be based on the stacking of oxygen close-packed layers that form a hexagonal structure. The structure appears to include two parts. One part is a four layer close-packed oxygen “ABCA” stack that is spinel-like in its structure. A second part is a conduction “slab” that has fewer oxygens and more space available, to accommodate the motion of sodium ions.

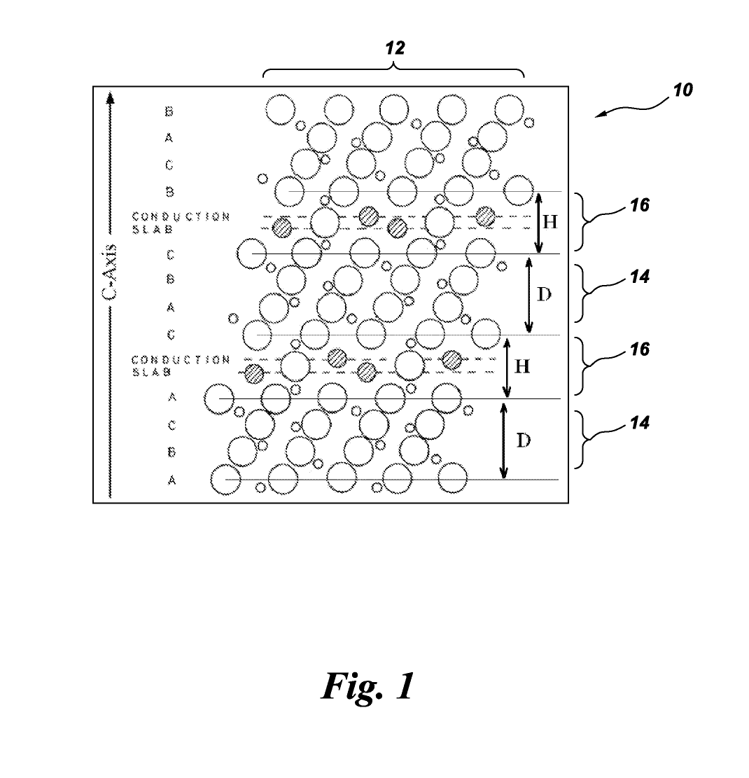

FIG. 1 is meant to illustrate this type of crystal structure 10, although some aspects of the exact structure have not been fully elucidated. The figure shows the stacking arrangement of close-packed oxygen layers 12 that form the structure. Spinel-related blocks are designated as elements 14 (or “D”); while conduction slabs are designated as elements 16 (or “H”). The crystal structure illustrated in the figure can be stabilized by the addition of divalent ions of manganese that substitute for aluminum, thereby increasing the amount of sodium in each formula unit. An idealized chemical formula for the phenomenon can be expressed as follows:

Na₍₁₊ₓ₎MnₓAl₍₁₁₊ₓ₎O₁₇→Mn-stabilized Na-Beta″Alumina

It is thought that stabilization is achieved by a dissolution mechanism. Additional amounts of sodium that accompany the dissolution of an oxide of manganese (MgO) appear to enrich the conduction plane 16 of the structure shown in FIG. 1. This enrichment increases the overall ionic conductivity of the structure. Apparently, the presence of manganese “shrinks” the alumina spinel blocks, and increases the height of the conduction plane. This, in turn, results in increased mobility of sodium ions through the conduction plane. Additional information regarding these concepts can be found in the following sources, which are all incorporated by reference: “The Crystal Structure of Na₂O MgO 5Al₂O₃ with Reference to Na₂O 5Al₂O₃ and Other Isotypal Compounds” by M. Bettman and C. R. Peters, Journal of Physical Chemistry, 73, pages 1774-1780 (1969); “Structure and Propeties of Sodium Aluminates”, Thery, J. and D. Briancon, Rev. Haut Temp. Refract, 1964, 1; p. 221 (French); and “Conduction Plane and Structure of Li-Stabilized Na⁺ Beta″-Alumina”, Jorgensen, J. D. et al, Solid State Ionics, 1981, 5: p. 143-146.

There are other advantages to using manganese in the separator compositions. As an example, manganese is a relatively abundant element that can be economically purchased from many sources. Moreover, handling and storing certain manganese-based materials can be easily carried out. For example, the manganese-stabilized beta alumina material is much less hygroscopic than magnesium-based beta alumina.

The separator compositions may include other additives as well. In some embodiments, at least one dopant is present. Examples include one or more oxides of iron, nickel, copper, chromium, cobalt, or molybdenum. It appears that the dopant can sometimes further enhance the sodium ion conductivity of the separator material. The dopant would be used at a very low level, e.g., less than about 1% by weight dopant (total), based on the total weight of the separator composition; and preferably, less than about 0.5% by weight.

The separator structure of the present invention can be manufactured by various methods that may involve one or more of these steps: sintering, subsequent forging of the sintered item, and crystal growth using, for example, flux methods. Ceramic additives can sometimes be used to treat the resultant ceramic monolith. Constituents like zirconium, yttria-stabilized zirconia, or selenium may be helpful additives for the composite separator material during formation.

Alternatively, a suitable separator can be formed by making a composite of alpha-alumina and an oxygen-ion conductor, and then exposing the composite to a vapor, fume or plasma containing an alkali-metal oxide. A suitable oxygen-ion conductor may include one of the above-mentioned metal-oxides and stabilized metal oxides. Suitable alkali-metal oxides may include sodium oxide. The vapor, fume or plasma may include one or more of the stabilizers mentioned herein, to inhibit transformation of beta″-alumina to the beta-alumina. Alternatively or additionally, the stabilizer may be added to the composite. Other details regarding manufacturing and processing can be found, for example, in U.S. Pat. No. 7,632,604 (Iacovangelo et al), incorporated herein by reference.

A suitable separator formed from a ceramic composite may start as alpha-alumina, with an oxygen-ion conductor formed as a green body. The green body may be processed by pressing, extrusion, slip casting, injection molding, tape casting, and the like, followed by sintering or hot-pressing. The physical properties of the final product derive in large part from those of the initial ceramic composite, and from the processing of the green body. In some preferred embodiments, the alpha-alumina and the oxygen-ion conductor are present in the green body in amounts sufficient to form continuous matrices of an alpha-alumina phase and an oxygen-ion conductor phase. This provides two continuous and interpenetrating networks. The amounts may be in a range of from about 90 vol. % to about 70 vol. % of alpha-alumina, and from about 10 vol. % to about 30 vol. % of oxygen-ion conductor. In some embodiments, the green body may be exposed to the appropriate ion species (as a metal oxide) in the form of an alkali-metal-oxide vapor, fume or plasma, at an elevated temperature greater than about 800° C. and less than about 1700° C. (at ambient pressure). The temperature may be based on the evaporation loss of the alkali-metal oxide.

The vapor, fume or plasma may include the oxide of the alkali-metal and, optionally, the stabilizing ion, if the beta″-form is desired. The green body may be packed in a powder of the vapor, fume or plasma precursor, which, when heated to reaction temperature, produces the vapor, fume or plasma. During the conversion process, oxygen ions transport through the oxygen-ion conductor, while sodium ions transport through the green body.

Some of the methods for sealing the separator to a housing that encloses a particular electrochemical device are known in the art. Glassy compositions are sometimes employed, and the particular sealing method will depend in large part on the operating temperature of the cell, as well as physical and chemical conditions to which the cell will be exposed. Many other details regarding separator structures and related devices can be found in the Iacovangelo patent, referenced above.

As alluded to previously, the separator structure described herein can be used in a number of devices. Non-limiting examples include various types of batteries, as well as fuel cells and some forms of electric converters, e.g., AMTEC devices. In some preferred embodiments, the thermal batteries, such as sodium-sulfur and sodium metal chloride batteries, are preferred end-uses for the separator structure and composition.

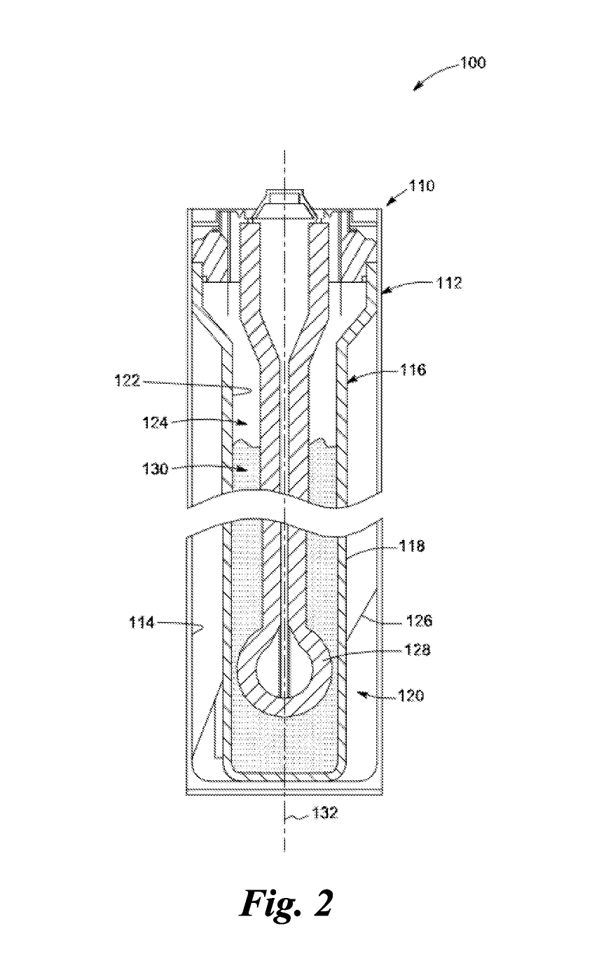

FIG. 2 is a representative electrochemical cell that can include the separator structure. Cell 100 is described in terms of a front cross-sectional view 110. The cell 100 includes a housing 112. The housing 112 has an interior surface 114, defining a volume. A separator 116 (i.e., the alkali metal ion conductor, as described herein) is disposed inside the housing 112. The separator 116 has a first surface 118 that defines a first compartment 120, i.e., an anode compartment. The separator has a second surface 122 that defines a positive electrode compartment 124. An anode current collector 126 is connected to the anode compartment 120. (The current collectors represent one device for delivering current from the cell to another location, as those skilled in the art understand).

A positive electrode current collector 128 is connected to the positive electrode compartment 124. A positive electrode composition 130 is disposed inside the positive electrode compartment 124. The positive electrode composition 130 mainly includes at least one electroactive metal, iron, an alkali metal halide, and an electrolyte salt. The working temperature of the electrochemical cell 100, when it is a sodium-nickel chloride cell, is usually about 300° C., although the specific temperature can vary.

The housing can be sized and shaped to have a cross-sectional profile that is square, polygonal, circular, or cloverleaf, to provide maximal surface area for alkali metal ion transport; and can have a width-to-length ratio that is greater than about 1:10, along a vertical axis 132. In one embodiment, the length-to-width ratio of the housing is in a range of from about 1:10 to about 1:5. The housing can be formed from a material that is a metal, ceramic, or a composite. The metal can be selected from nickel or steel, and the ceramic is typically a metal oxide.

The ionic material transported across the separator between the anode compartment and the positive electrode compartment can be an alkali metal. Suitable ionic materials may include one or more of sodium, lithium and potassium. As mentioned elsewhere, sodium is often used, as a component in a sodium-nickel chloride cell.

Typically, the anode compartment is empty in the ground state (uncharged state) of the electrochemical cell, and is then filled with metal from reduced metal ions that move from the positive electrode compartment to the anode compartment through the separator, during operation of the cell. The anodic material, for example, sodium, is molten during use. The first compartment or the anode compartment may receive and store a reservoir of anodic material. As also described in the Iacovangelo patent referenced above, additives may be used in the anodic material, e.g., oxygen scavengers and/or wetting agents.

As noted above, the separator is disposed within the volume of the housing 112. The separator may have a cross-sectional profile normal to a vertical axis 132 of the housing 112, for example, a circle, a triangle, a square, a cross, or a star. Alternatively, the cross-sectional profile of the separator can be planar about the vertical axis 132. A planar configuration (or one with a slight dome) may be useful in a prismatic or button-type battery configuration, where the separator is domed or dimpled. Similarly, the separator can be flat or undulated. In one embodiment, the solid separator may include a shape that may be flat, undulated, disc-shaped, cup-shaped, cylindrical, elongated, domed or dimpled; or that comprises a shape with a cross-sectional profile that may be an ellipse, triangle, cross, star, circle, cloverleaf, rectangular, square, or multi-lobal.

In the case of a tubular separator, the wall thickness of the tube will influence the ionic conductivity and the resistance across the wall. In some embodiments, the thickness of the wall is less than about 5 millimeters. A cation facilitator material can be disposed on at least one surface of the separator, in one embodiment. The cation facilitator material may include, for example, selenium.

Optionally, one or more shim structures can be disposed within the volume of the housing. The shim structures support the separator within the housing. The shim structures can protect the separator from vibrations caused by motion of the cell during use, and thus reduce or eliminate movement of the separator, relative to the housing. In one embodiment, a shim structure can function as a current collector. Those skilled in the art understand that the overall electrochemical cell can include a plurality of current collectors, including anode current collectors and positive electrode current collectors, as also described in the Iacovangelo reference.

As alluded to previously, another embodiment of this invention relates to an energy storage device. Such a device includes a plurality of electrochemical cells, each including the separator structure described herein. The electrochemical cells are, directly or indirectly, in thermal and/or electrical communication with each other. Those of ordinary skill in the art are familiar with the general principles of such devices.

### EXAMPLES

The examples that follow are merely illustrative, and should not be construed to be any sort of limitation on the scope of the claimed invention. Unless specified otherwise, all ingredients may be commercially available from such common chemical suppliers as Alpha Aesar, Inc. (Ward Hill, Mass.), Sigma Aldrich (St. Louis, Mo.), Spectrum Chemical Mfg. Corp. (Gardena, Calif.), and the like.

A manganese-stabilized beta alumina composition was prepared, based in part on the process used to form magnesium-based compostions of this type. The compositions containing manganese were formulated with a stoichiometry equivalent to x=0.7, where “x” is the extent of aluminum subsititution in the crystal structure illustrated in FIG. 1, relative to sodium and manganese.

Na₂CO₃, MnCO₃, and alpha-alumina were used as starting materials. The mixture was dry-milled for 4 hours, using zirconia milling media to achieve uniform mixing. The milling media was removed by fine-mesh sieving, and the resultant powder/precursor mix was loaded into an MgO crucible for heating. The temperature profile for first heating was a slow ramp to 950° C. (at about 2 degrees/minute) and held for one hour, followed by continued slow ramping to 1200° C. with a one-hour hold, which served to decompose the carbonates, and to initiate reaction. The sample was then furnace cooled back to ambient temperature. Subsequent, additional heat treatments to 1300° C. and 1400° C. were performed, also for one-hour peak-temperature hold times.

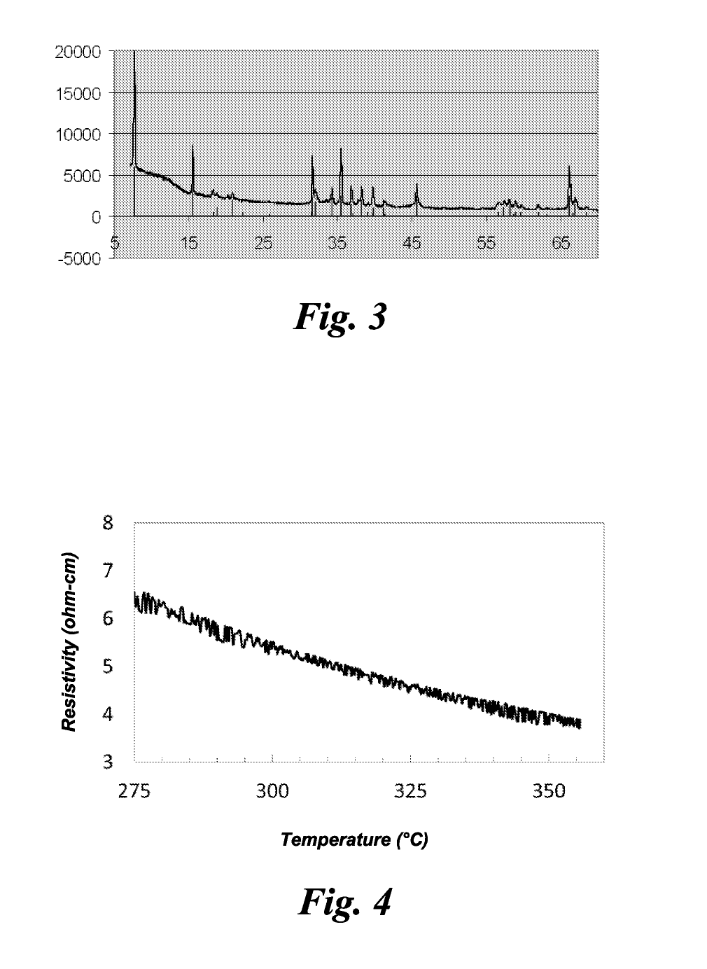

FIG. 3 is an X-ray powder diffraction pattern for the manganese-stabilized beta alumina phase. (The vertical lines are calculated peak locations). The figure shows that the patterns were a good match for the known structure of beta″-alumina.

Table 1, below, provides lattice parameters for the various manganese-stabilized samples. The table also includes comparative data for other known beta alumina samples, combined with conventional stabilizers.

TABLE 1

| | | “a” Value | “c” Value | |
|---|---|---|---|---|
| | Temperature | (lattice | (lattice | Source of |
| Sample Composition | (° C.) | parameter) | parameter) | Material/Comments |
| Na_{1.7}Mn_{0.7}Al_{10.3}O₁₇ | 1300 | 5.641(2) | 33.82(1) | |
| Na_{1.7}Mn_{0.7}Al_{10.3}O₁₇ | 1300 | 5.641(2) | 33.75(1) | |
| Na_{1.7}Mn_{0.7}Al_{10.3}O₁₇ | 1400 | 5.643(2) | 34.01(1) | (After water uptake |
| | (air) | | | from 72 hour air |
| | | | | exposure @ room |
| | | | | temperature) |
| Na_{1.67}Mg_{0.67}Al_{10.33}O₁₇ | | 5.6230(6) | 33.536(3) | (Published Literature) |
| Na_{1.57}Zn_{0.57}Al_{10.43}O₁₇ | | 5.6165(6) | 33.613(3) | (Published Literature) |
| Na_{1.82}Co_{0.70}Al_{10.2}O₁₇ | | 5.6153(9) | 33.712(5) | (Published Literature) |
| Na_{1.72}Li_{0.30}Al_{10.66}O₁₇ | | 5.6101(1) | 33.4627(4) | (Published Literature) |
| Na_{1.30}Ni_{0.30}Al_{10.70}O₁₇ | | 5.61(5) | 33.6(3) | (Published Literature) |

The data of Table 1, along with additional measurements of diffraction angles and peak locations, generally indicates that manganese provides stabilization by the same mechanism as other stabilizers. The data also showed that manganese-stabilized materials of the type described herein are characterized by a crystal phase with unit cell dimensions larger than any of the previously-known stabilized sodium-beta alumina phases.

FIG. 4 is a plot measuring resistivity, as a function of temperature, for manganese-stabilized beta″-alumina. The resistivity at about 300° C. (a typical operating temperature for a sodium nickel chloride battery) is about 5.3 ohm-cm, which is low enough to potentially enhance power values in the battery. While these resistivity tests show a modest improvement over comparable data for lithium beta″-alumina materials (about 5.8-6.5 ohm-cm), it is thought that additional optimization of the manganese-based material and techniques for its preparation can lead to additional, desirable decreases in resistivity values.

The present invention has been described in terms of some specific embodiments. They are intended for illustration only, and should not be construed as being limiting in any way. Thus, it should be understood that modifications can be made thereto, which are within the scope of the invention and the appended claims. Furthermore, all of the patents, patent applications, articles, and texts which are mentioned above are incorporated herein by reference.

What is claimed:

1. An electrochemical separator structure formed of a material that comprises manganese-stabilized beta″-alumina, wherein the manganese is present at a level of about 1% by weight to about 20% by weight.

2. The separator structure of claim 1, wherein the material comprises about 5% by weight to about 15% by weight of the manganese stabilizer.

3. The separator structure of claim 1, in the form of a sodium ion conductor solid electrolyte.

4. The separator structure of claim 1, wherein the material consists essentially of (i) sodium oxide, (ii) beta″-alumina, and (iii) about 1% by weight to about 20% by weight of manganese.

5. The separator structure of claim 1, having a shape that is cylindrical, elongated, tubular, cup-shaped, planar, or disc-shaped.

6. The separator structure of claim 1, having a cross-sectional profile that comprises a cloverleaf shape.

7. An energy storage device, comprising the electrochemical separator structure of claim 1.

8. The energy storage device of claim 7, in the form of a sodium-based thermal battery.

9. A sodium metal halide battery according to claim 8.

10. An electrochemical cell, comprising:
a) a housing, having an interior surface defining a volume;
b) a separator disposed in the volume, and positioned to separate a cathode from an anode; and
c) means for delivering current from the cell to another destination;
wherein the separator is formed of a material that comprises manganese-stabilized beta″-alumina, wherein the manganese is present at a level of about 1% by weight to about 20% by weight.

11. An energy storage device, comprising a plurality of the electrochemical cells of claim 10, wherein the cells are in electrical communication with each other.
